(19) United States
(12) Patent Application Publication
(10) Pub. No.: US 2009/0093164 A1
(43) Pub. Date: Apr. 9, 2009

(54) HIGH-DEFINITION CONNECTOR FOR TELEVISIONS

(75) Inventors: Ming-Chieh Lee, Bellevue, WA (US); Amir Hossein Majidimehr, Woodinville, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 11/866,653

(22) Filed: Oct. 3, 2007

(51) Int. Cl. H01R 24/00; H04N 5/66

(52) U.S. Cl. 439/626; 348/739; 348/E05.133

(57) ABSTRACT

A connector is disclosed that includes one or more pins allowing power to be provided to a connector board attached externally to the television set. In one embodiment, the connector has one or more USB pins to allow serial communication between the television set and the connector board. In another embodiment, the connector has one or more pins to allow communication of television setup information to the connector board. In yet another embodiment, the connector board may use the setup information provided from the television to perform audio processing and deliver enhanced audio sound to the speaker system associated with the television. The connector board may also wirelessly communicate with a personal computer, thereby coupling the personal computer to the television set.

### FIELD

The present invention relates generally to televisions, and, more particularly, to connecting new features or functionality to televisions for display.

### BACKGROUND

The television remains the primary display of today's household. It is typically the largest display and often holds a prominent space in the household's family room or living room. There are a number of techniques to add features or functionality to televisions. One technique is to use a set-top box that includes the desired features and connect the set-top box to the television's external connectors. This well-known approach is used for cable television, satellite television, DVD players, Media Center Extender, etc. Unfortunately, the number of devices that can be connected to the television is continuously increasing (e.g., personal computers, game boxes, etc.). And with the increase in devices comes a corresponding increase in boxes, remote controls and cables. Power cables extending from the source devices must be plugged into outlets. Cables carrying the media signals must be plugged into the television. The result is a clutter of cables and wires in and around the television. With the prominent location of the television, known solutions require building a cabinet to hide the unsightly cabling. It is common place to hear complaints from consumers about too many devices, too many wires, and too many remote controls. Consumers now avoid buying new devices simply because they are running out of space. Flat panel televisions that hang on a wall only exacerbate the visualization of the cable clutter.

Some televisions have included additional features built in, such as digital cable tuners and DVD players integrated into the television itself. This option reduces the stack of set-top boxes and associated cabling. A problem with this solution is that every television company has different architectures, platforms and circuitry. Thus, it is difficult for a new technology provider to offer components that work on the varied television platforms.

As a result, there is a need to allow new technology providers to connect to a television in a standard way that is compliant with the varied television platforms and that does not unduly increase cabling.

### SUMMARY

The present invention overcomes the drawbacks of the prior art by providing a connector that allows a connector board (e.g., printed circuit board) to connect to a television set without cables.

In one embodiment, in addition to standard HDMI data pins, the connector has one or more pins allowing power to be provided to the connector board from the television set. In another embodiment, the connector has one or more USB pins to allow serial communication between the television set and the connector board. In yet another embodiment, the connector has one or more pins to allow communication of television setup information to the connector board. In another embodiment, the connector board may use the setup information provided from the television set to perform audio processing and deliver enhanced audio sound to the speaker system associated with the television. In yet another embodiment, the connector board may wirelessly communicate with a personal computer, thereby coupling the personal computer to the television set and making the television set part of the home network.

The foregoing and other objects, features, and advantages of the invention will become more apparent from the following detailed description, which proceeds with reference to the accompanying figures.

### BRIEF DESCRIPTION OF THE DRAWINGS

FIG. 1 is a system diagram showing a television set coupled to a home network through a wireless system.

FIG. 2 is a side-profile view of the television set having an external connector for coupling a cable-less connector board.

FIG. 3 is a flowchart of a method for receiving display information through the cable-less connector board of FIG. 2 for display on the television set.

FIG. 4 is a flowchart of a method for powering the cable-less connector board through the television connection.

FIG. 5 is a flowchart of a method for receiving television setup information in the cable-less connector board to process audio or video information.

FIG. 6 is a flowchart of a method for communicating with the television set through a USB port.

FIG. 7 shows an embodiment of the connector board.

### DETAILED DESCRIPTION

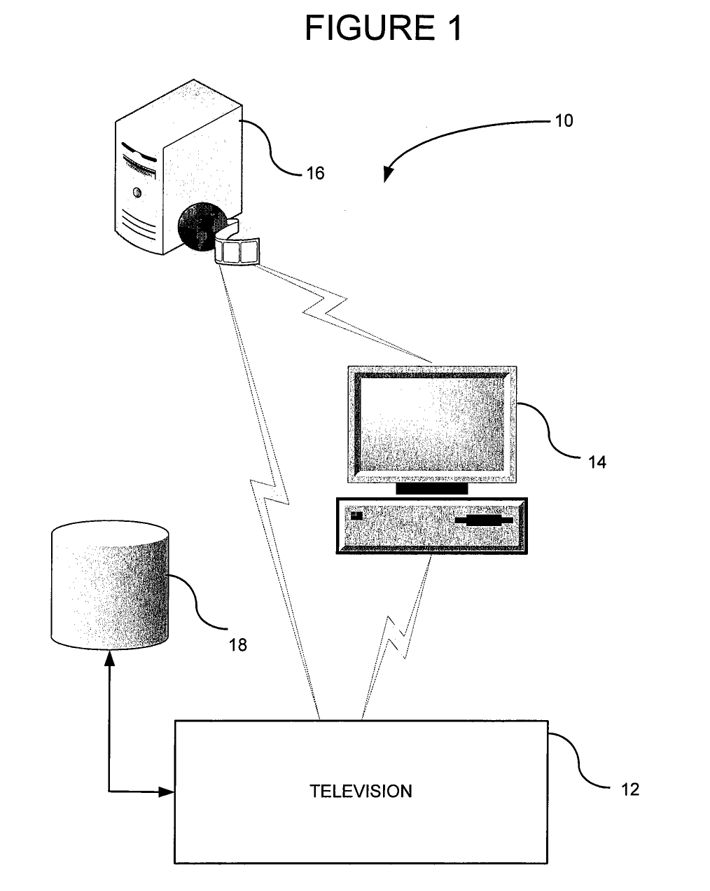

FIG. 1 shows a system 10 for displaying images on a television set 12. The system 10 can be, for example, a home system including one or more of the following additional components: a personal computer 14, an Internet server 16, and a database 18.

Typically, the personal computer 14 is a large repository of media, such as music, photos, video, etc., that desirably is consumable on a principle entertainment system. As shown, the personal computer 14 is wirelessly coupled to the television set 12, as further described below, so that any desired images or multimedia content can be displayed.

There is also a desire to bypass the personal computer 14 and display Internet-related content directly on the television set 12. The Internet server 16 may be wirelessly coupled to the television 12 for this purpose. The server 16 may host rich web-based content including audio, video, image, and text to provide an interactive experience on the television set. The database 18 may be also coupled to the television set 12, as further described below. The database 18 allows direct access to display media stored thereon.

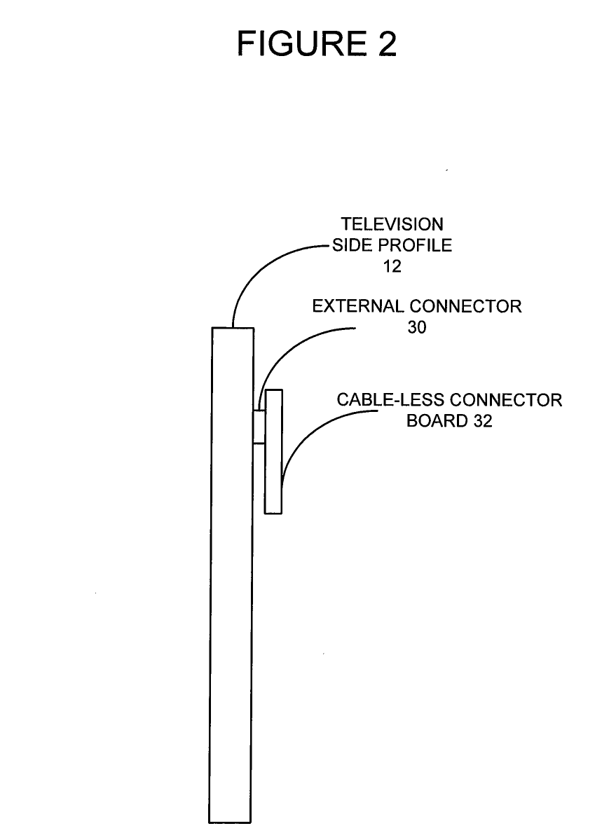

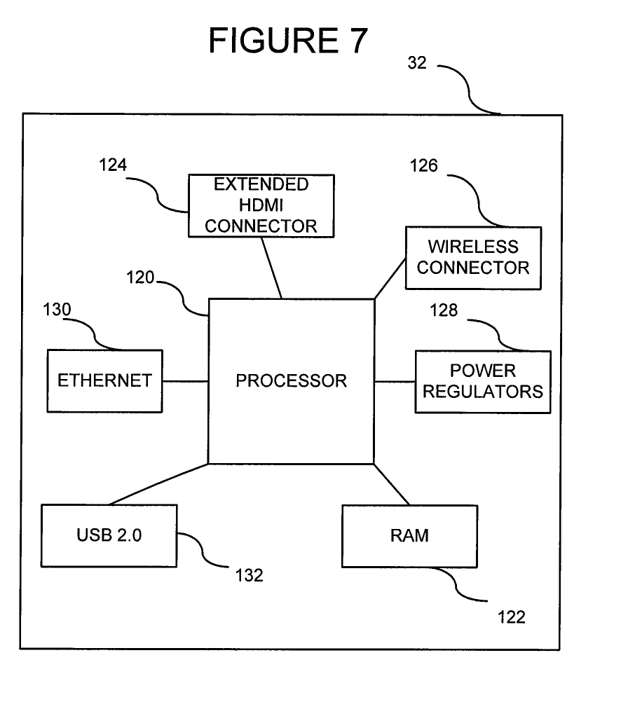

FIG. 2 is a side-profile view of the television set 12 having a connector 30 for coupling a cable-less connector board 32, which may be a printed circuit board. A detailed example of the connector board 32 is described further below in FIG. 7. Generally, the board 32 allows for wireless connection between the television and external devices, such as the personal computer 14. The connector 30 uses the HDMI pin set as a base, but adds non-standard HDMI pins in order to meet the needs of the connector board 32. For example, additional pins are added to provide a USB interface, a television setup information exchange, and power. The standard HDMI connector does have a pin for power, but it uses a source-to-sink setup, where the television set is the sink. The connector 30, instead, supplies power from the television set 12 to the cable-less connector board 32 creating a sink-to-source power supply. In this way, the connector board 32 does not need a separate power cord. The pin or pins added to exchange television setup information can use any desired communication format. Pins for communicating the HDCP protocol may also added to the pin set in order to handle decoded high-definition output for protected media files. The connector may also include a remote IR pin so that an additional remote control is not needed to control the connector board 32. Instead, the television can communicate through the connector 30 indicating any information relating to the television remote control. The USB interface pins allows the connector board 32 to access the external database 18 and communicate information received from the database 18 to the television set 12. The connector 30 is typically located on the backside of the television set in such a way that the connector board 32 may plug directly into the connector without a cable using a standard male/female connection scheme.

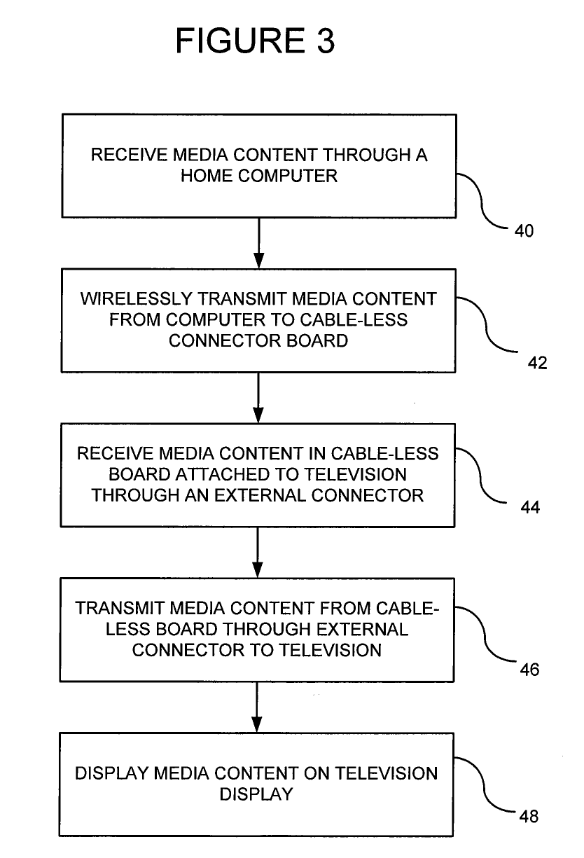

FIG. 3 shows a flowchart of a method for using the connector board 32. In process block 40, media content is received on the computer 14. The media content may include one or more of the following: photos, music, video, movies, text, etc. Media content may be directly loaded onto the computer 14 or transmitted thereto by server 16 as shown in FIG. 1. In process block 42, the media content is wirelessly transmitted from the computer 14 to the cable-less connector board 32. Such wireless communication may use standard wireless techniques, such as IEEE 802.11n and 802.11g. Other standards may be used. In process block 44, the connector board 32 receives the media content. The connector board 32 is physically attached and electrically connected to the television through the external connector 30. In process block 46, the received media content is transmitted through the connector 30 to the television 12. In process block 48, the television displays the media content. Thus, without unsightly cables, the television effectively is coupled to a network of computers to display any desired content. In addition to receiving content from computer 14, the television set 12 may also receive Internet content directly from the server 16.

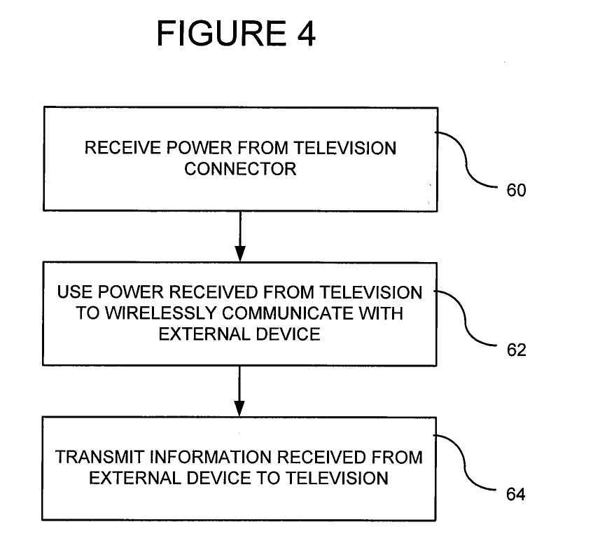

FIG. 4 shows a flowchart of a method for powering the connector board 32. In process block 60, power is received from the television through the connector 30. As described above, existing connectors do not allow the television to supply power to an external board. However, the power pin of connector 30 is designed to be able to supply power using standard techniques. The voltage and current levels depend on the particular connector board, but a standard voltage level may be 5 volts DC. In process block 62, the connector board 32 uses power received from the television set to establish a wireless communication between the connector board 32 and an external device, such as personal computer 14. In process block 64, the connector board receives media data from the external device and communicates that data to the television set 12 for display. Power may be supplied through a single pin with ground supplied through the connector casing. Alternatively, more than one power pin may be supplied (e.g., a separate ground pin) depending on the application.

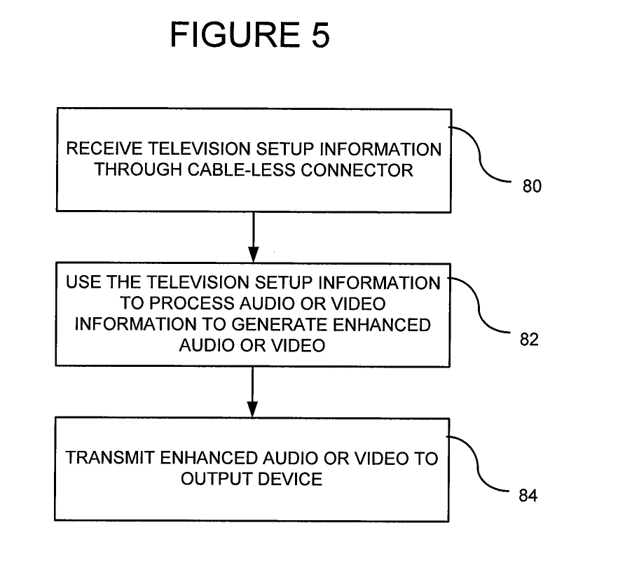

FIG. 5 shows a flowchart of a method for communicating television setup information to the connector board 32. In process block 80, the television 12 transmits setup information, such as speaker type, through the connector 30. In process block 82, the television setup information is used to process audio or video data to enhance the audio or video for the particular television. For example, the connector board may provide volume equalization. When there are multiple audio tracks in a play list with multiple formats such as MP3, WMA or AAC, each potentially having different volume levels, the board 32 may adjust the volume accordingly to provide a more uniform volume level. Likewise, the volume equalization may control the volume level during commercials of different television channels that are often not at a uniform volume level. Additionally, the connector board 32 may provide bass boost. Most television speakers are small- to mid-range speakers that are unable to reproduce low frequencies efficiently. The connector board may therefore boost the base frequencies to optimize sound quality. The connector board 32 may also provide speaker correction. Televisions often have poor speakers. By passing the speaker type to the connector board 32, the board may fill frequency holes in the speaker reproduction spectrum and also make the roll-off sound shallower by boosting edges of the reproducible spectrum. Finally, the connector board may perform speaker widening. Flat panel displays often do not have an optimal wide soundstage. The connector board 32 may process the audio signals to widen the soundstage for stereo content to create a virtual soundstage that is much larger than the distance between the television speakers. In process block 84, the enhanced audio or video signals are transmitted to the output device, such as speakers.

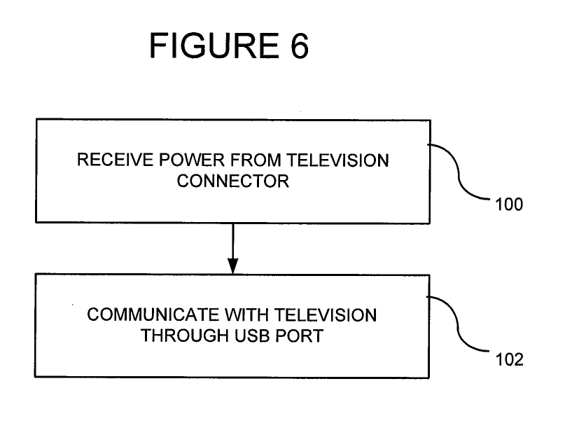

FIG. 6 shows a flowchart of a method for communicating with the television set through the connector 30 using a USB port. In process block 100, power is received through the connector as already described. In process block 102, the connector board 32 communicates with the television through the USB pin(s) in the connector 30. The USB pin can be used to download any desired data to television set 12 from the connector board 32. For example, Internet content can be downloaded from the connector board 32 to the television set 12. Such Internet content can be received directly from the Internet server 16 or from the PC 14. In another example, movie data is downloaded from the connector board 32 to the television set for storage and display. The television set can also pass data to the connector board 32. Some television companies are attempting to standardize a new television connector for connecting external hard drives directly to the television. In such a case, the television can pass data stored on the external hard drive through the USB port to the connector board 32. The connector board can then pass such information to the personal computer 14. Or an external hard drive 18 may be directly coupled to the connector board 32 and data from the hard drive 18 can be downloaded to the television through the connector board.

FIG. 7 shows an example connector board 32. The connector board can be designed in multiple ways depending on the particular application. The connector board may include a processor 120. One implementation uses the Broadcom BCM 7405 processor that combines support for features, such as one or more of the following:
1) A 600 DMIPS MIPS32/MIPS 16e-class CPU
2) A graphics processing engine that includes video scaling and motion adaptive deinterlacing.
3) A data transport processor.
4) A VC-1/H.264/MPEG-2 compliant video decoder.
5) A programmable audio decoder.
6) Multiple video digital-to-analog converters.
7) Stereo audio digital-to-analog converters.
8) Dual Ethernet ports.
9) USB 2.0.
10) A PCI 2.3/Expansion bus.
11) A 400 MHz DDR2 memory controller.
12) A peripheral control unit that provides a variety of control features.

Other processors with different features may be used. In addition to the processor 120, the connector board may include RAM 122 (e.g., 256 MB of flash memory and 512 MB DDR2 memory). An extended HDMI connector 124 includes the standard HDMI pin set plus extra pins including one or more pins for powering the connector board 32 from the television set, one or more pins for the USB port, and one or more pins for communicating television setup information to the connector board 32. A remote control IR pin may also be added. A wireless connector 126 allows communication between the connector board 32 and one or more remote PCs (e.g., computers 14, 16 from FIG. 1). One or more power regulators 128 are used to ensure power received from the television set is a proper voltage level for the connector board 32. An Ethernet connector 130 allows the connector board 32 to attach directly to a network, so that the television set 12 is effectively part of a network. A USB port 132 is used to attach an external hard drive 18. The USB port 132 may also be used for other purposes, such as attaching a camera for video conferencing over IP, attaching an HD DVD drive, etc.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for displaying images on a television set, comprising:
providing a printed circuit board positioned externally from the television set and physically attached and electrically connected to the television set without cables;
receiving power from the television set in order to power the printed circuit board;
receiving media data on the printed circuit board using the power received from the television set;
transmitting the media data from the printed circuit board to the television set; and
displaying the media data on the television set.

2. The method of claim 1, wherein receiving media data on the printed circuit board includes wirelessly receiving the media data from a personal computer.

3. The method of claim 1, wherein transmitting the media data includes communicating the media data to the television through an HDMI-compatible data transmission.

4. The method of claim 1, further including receiving in the printed circuit board, television setup information transmitted from the television set to the printed circuit board.

5. The method of claim 4, wherein the setup information includes information related to audio components connected to the television set.

6. The method of claim 5, wherein the audio components include speakers coupled to the television set.

7. The method of claim 6, further including receiving an audio signal on the printed circuit board to be played over the speakers, and processing the audio signal using the setup information received from the television set.

8. The method of claim 1, further including communicating between the television set and the printed circuit board using a universal serial bus.

9. A connector for a television set, comprising:
connector pins for complying with data transmission according to a high-definition multimedia interface; and
a power pin for supplying power from the television set to an externally connected board physically attached to the television set.

10. The connector of claim 9, further including a pin for communicating television setup information to the board.

11. The connector of claim 10, wherein the television setup information includes speaker information associated with speakers connected to the television set.

12. The connector of claim 9, further including one or more pins for establishing a USB connection between the board and the television set.

13. A system for displaying images:
a television set;
a board physically attached and electrically connected to the television set without cables; and
a personal computer communicating with the board to allow communication between the television set and the personal computer.

14. The system of claim 13, further including speakers coupled to the television set, wherein the television set communicates information to the board regarding the speaker type.

15. The system of claim 13, further including an external disk drive coupled to the board.

16. The system of claim 15, further including a USB connection between the television set and the board to couple the external disk drive to the television set.

17. The system of claim 13, wherein the board communicates with the television through data pins complying with an HDMI standard.

18. The system of claim 13, wherein the board includes a processor thereon for processing audio information to be played over the speaker system associated with the television set.

19. The system of claim 13, wherein the board includes a connector including an HDMI standard with additional pins for supplying one or more of the following features: power, a USB port, television setup information.

20. The system of claim 13, further including power regulators positioned on the board.
